(19) United States
(12) Patent Application Publication
(10) Pub. No.: US 2005/0118327 A1
(43) Pub. Date: Jun. 2, 2005

(54) Tropicalizing agent, and methods for making and using the same

(76) Inventors: Eric T. Best, Dublin, OH (US); David Oakenfull, Turramurra (AU); Michelle Maladen-Percy, Centerville, OH (US); Robert T. Boehm, Marysville, OH (US); Lawrence A. Kibler, Marysville, OH (US)

Correspondence Address: WINSTON & STRAWN;PATENT DEPARTMENT, 1400 L STREET, N.W., WASHINGTON, DC, 20005-3502, US

(21) Appl. No.: 10/725,292

(22) Filed: Dec. 2, 2003

(51) Int. Cl. A23G 3/00

(52) U.S. Cl. 426/660

(57) ABSTRACT

A tropicalizing agent including a liquid fat component and a plurality of gel beads that include a sugar or polyol in an amount of about 20 to 50 weight percent of the gel beads, an emulsifier component to facilitate uniform gel bead distribution, and the remainder being water present in an amount sufficient to ensure that the sugar or polyol is present in aqueous form. Preferably, the liquid fat component is present in an amount sufficient to disperse the gel beads therein and wherein a majority of the gel beads remain substantially intact for at least about 4 hours after being cooled below about 30° C. Methods of making tropicalizing agents and using the agents to tropicalize chocolate products or analogues thereof, as well as the resultant chocolate or chocolate analogue articles, are also included.

### TECHNICAL FIELD

The present invention is directed to tropicalizing agents, methods of making the same, and methods of tropicalizing chocolate or chocolate analogues, and resultant articles with the same to increase resistance to loss of shape.

### BACKGROUND ART

Conventionally manufactured chocolate consists of sugars, cocoa solids and protein (usually from milk) homogeneously dispersed in fats and fatty substances originating from cocoa butter. Chocolate analogues contain other vegetable fats. Often the continuous fat phase also contains dairy fat.

Since the fatty components are the continuous phase of chocolate, the storage stability and temperature behavior primarily depend on the physical properties of the fat phase. Cocoa butter is polymorphic. Six crystal forms have been described—with different melting characteristics as noted below in Table 1 (G. Talbot, Fat eutectics and crystallization. In Physico-chemical aspects of food processing (Beckett, S. T., ed.). Blackie Academic and Professional, London, 1995, pp. 142-166.) Tempering, as part of the process of manufacturing chocolate, is aimed at ensuring that cocoa butter crystallizes mainly in the crystal forms V and VI which have the highest melting temperatures.

TABLE 1
Melting points of cocoa butter polymorphs

| Crystal | Melting point |
|---|---|
| form | (° C.) |
| I | 16-18 |
| II | 21-22 |
| III | 25.5 |
| IV | 27-29 |
| V | 34-35 |
| VI | 36 |

Nonetheless, the cocoa butter typically starts to soften at about 28° C., with consequent loss of the mechanical strength of the chocolate. This means that at the high ambient temperatures frequently encountered in tropical countries, chocolate becomes sticky or even runny. It tends to stick to the wrapper and fall apart when the wrapper is removed, leaving a semi-liquid mass that can often only be eaten with a spoon if cleanliness is desired. Enrobed chocolate products typically lose integrity under these conditions, with their contents often leaking and individual units tending to stick together in the packaging. Chocolate also loses the ‘snap’ that is an important (and pleasurable) textural characteristic of chocolate stored and eaten under cooler conditions. Another problem associated with the low melting point of cocoa butter is that of blooming, which is caused by the separation of the melted cocoa butter on the surface of chocolate products at higher temperatures followed by its subsequent crystallization as the temperature falls. This gives an unpleasant grayish appearance to the product, reminiscent of mold. Repeated exposure to long hot and cold cycles is particularly likely to encourage blooming.

Attempts to produce a chocolate that is resistant to heat are numerous and date back to the beginning of the last century. German Patent No. 389 127 (1919), for example, describes an invention where water is mixed with cocoa mass and sugar, which is reported to provide a solid, heat-stable chocolate mass. Some of the more recent developments have built on this principle of adding water to chocolate to increase its viscosity, thereby making it heat resistant.

The techniques currently used to achieve heat resistance in chocolate can be divided into the following two groups, depending on the approach used: 1) incorporation of high-melting point fats; and 2) creation of a three-dimensional matrix or network of sugar crystals or protein particles that will act as a sponge and hold the fat—thus maintaining the structure of the product even when the fat is actually liquid. In general, many different methods have been reported. Often the methods used overlap and products gain their heat stability from a combination of structure stabilizing strategies.

Incorporation of high-melting fats is the less often used method to increase heat resistance in chocolate. For example, it has long been known that illipe butter (Borneo tallow) can be used to increase the heat resistance of chocolates and coatings intended for tropical conditions (see, for example, Lees, R. & Jackson, E. B., Sugar confectionery and chocolate manufacture, Leonard Hill, 1973, pp. 149-151.) Illipé comes from a tree seed not unlike cocoa beans. It is similar to cocoa butter (and hence physically compatible with it) but has a slightly higher melting temperature (37-38° C.). Modified vegetable fats have been developed as substitutes for cocoa butter that improve the heat stability of the product, as well as making it cheaper to produce. They are mainly obtained by partial hydrogenation of the natural fats which results in transformation of unsaturated into saturated and trans fatty acids, increasing the melting point (see, for example, British Patent No 1 595 706 (1978)). Alternatively, blends of fats and fractions of fats from different sources can be used, thus enabling tailor-made manufacture of chocolate ingredients with distinct melting behaviors, as disclosed in British Patent No 1 495 254 (1973).

There are two major objections, however, to the use of high-melting fats in chocolate. First, food regulations in many countries restrict the use of substitutes for cocoa butter. Second, high-melting point fats in chocolate-like products give an unpleasant waxy mouthfeel. This is because the fat now has too high a melting point to melt in the mouth and thereby provide the attractive ‘clean’ mouthfeel characteristic that exists in conventional chocolate and is expected by consumers of chocolate and chocolate analogues. Thus, high-melting point fats tend not to be widely used.

The other method of increasing heat resistance is the creation of structure in the continuous fat phase. In this method, a network structure is typically built up from non-fat particles, such as sugar crystals or milk proteins. This can form a porous structure that can help hold the liquid fat like a sponge while at the same time conferring sufficient mechanical rigidity to maintain the structural form of the product.

Most methods for building such structures exploit the fact that moisture in the chocolate mass can cause adhesion of sugar crystals. For example, attempts have been made to develop structure by using less intensive and shortened conching of a ready-mixed chocolate mass. This supposedly leaves a proportion of the surfaces of the sugar and milk particles free of any coating of fat—the fat being melted and distributed over only enough of the particle surfaces to give the degree of fluidity needed for subsequent operations. Moisture in the mass then causes adhesion of adjacent bare faces of sugar crystals, which thereby form a sponge-like structure that resists deformation of the mass at higher temperatures where the fat is liquid.

One drawback of this method is a poorly developed chocolate flavor, as disclosed in U.S. Pat. No. 2,760,867 (1951). This patent describes a method that allows the manufacture of heat-stable chocolate products with fully developed chocolate flavor. A small amount (<3%) of water containing an emulsifier (including among others lecithin, polyoxyethylene sorbitan mono-oleate, sorbitan monostearate and sorbitan monopalmitate) is added under controlled conditions of temperature (80-95° C.) and agitation. Supposedly this provides for preferential adsorption of the water by the skim milk solids. The product is then tempered in the usual way before being used for molding or enrobing. The patent teaches that the milk solids become swollen and at least partly conjoined, thus providing a stable network.

A slightly different method has been disclosed in U.S. Pat. No. 2,904,438, where humectants such as glucose syrup solids, dextrose, maltose, sucrose, sorbitol, mannitol and the like are incorporated with other chocolate ingredients before the refining step. The sugars should preferably be in the amorphous state, thus providing for the best moisture-adsorbing properties. The product is then exposed to humid conditions (50-70% relative humidity) for 2-4 weeks. The patent teaches that after moisture absorption the humectants interact with the protein components of the milk powder particles to establish a network structure.

Another method using polyols is disclosed in U.S. Pat. No. 5,445,843 (1995). The polyol (such as glycerol) is encapsulated by emulsifying it with a liquid fat (such as molten cocoa butter) then spray-chilling the emulsion. The “capsules” (which have an average diameter 100 microns) are added to liquid chocolate mass to achieve a polyol content of from 0.2 to 5% by weight. The product remains liquid long enough to be molded.

A method for the manufacture of a chocolate product that is heat resistant but does not contain any milk components (i.e., plain chocolate) is disclosed in Swiss Patent No 399, 891 and German Patent Application No 1,929,447. In this invention, a finely ground amorphous sugar mixture is prepared from sucrose and an anticrystallizing substance, such as glucose syrup or invert sugar. The sugar mixture is mixed with a conched conventional chocolate mass that contains crystalline sucrose. The mass is then tempered at about 30° C. in the conventional way. The shaped and cooled chocolate products are hermetically wrapped and stored for between 10 and 60 days at a temperature between 20° C. and 35° C. The two patents teach that, during this heat treatment, the amorphous sugar particles stick together forming a sponge-like network that prevents collapse of the product at more elevated temperatures. This method suffers from the disadvantages of requiring extra equipment for preparation of the finely ground amorphous sugar mixture and the time-consuming heat treatment for development of the network structure.

Japanese Patent No 53-59072 discloses a method of avoiding a lengthy heat treatment by using an amorphous sugar coated with sodium caseinate, or a mixture of sodium caseinate and non-fat milk solids. The coated amorphous sugar portion (15 to 20%) is added with all the other chocolate ingredients before roller refining and the chocolate mass is processed using the conventional steps. During conching, the moisture content of the chocolate mass is adjusted to not less than 1.6% but not more than 3%. The shaped and cooled chocolate products are wrapped and stored at a temperature between 20° C. and 30° C. for two weeks to establish the sugar network. The patent teaches that cooking the amorphous sugar with sodium caseinate, or a mixture of sodium caseinate and non-fat milk solids, prevents immediate moisture absorption (and therefore crystallization of the amorphous sugar) during the processing of the chocolate mass. Sodium caseinate, however, tends to adversely affect the flavor characteristics of chocolate.

A different approach is disclosed in British Patent No 1,490,814 and Swiss Patent No 519,858. In this method, a sugar network provides a stable structure at elevated temperatures, but without the disadvantage of surface “oiling-off” encountered in earlier methods. The British Patent discloses a method in which the fat component of a chocolate formulation is emulsified in a highly concentrated aqueous sugar solution. Sufficient water is evaporated from the solution to inhibit separation of the fat phase which is reportedly thereby encapsulated in an amorphous sugar matrix during the shaping and drying of the heat resistant product. An emulsifier (lecithin at 0.4 to 1.1%) is used for stabilizing the emulsion. This method provides a chocolate product with a highly unusual texture.

In another, very different, approach, U.S. Pat. No. 4,701,337 (1985) discloses a method for preparation of a thermally reversible thixotropic material (described as a gel) consisting of cocoa butter and a hydrated dipeptide sweetener, such as aspartame. This is used as the fat component, mixed with the conventional chocolate components and then refined, conched and tempered in the usual way. The “gel” typically constitutes 5 to 40% by weight of the final product. The inventors report that the cocoa butter is held within the gel structure, giving a chocolate that will not “melt” at hand or body temperature.

Many methods have been described for causing accretion of sugar crystals by adding water or a polyol to chocolate, as originally disclosed in German Patent No. 389 127 (1919) mentioned earlier. A more recent variation is disclosed in Swiss Patent No 409,603 (1962). Water is added directly to liquid chocolate mass causing a rapid increase in viscosity. As a result, it is impossible to use this material for molding or enrobing. Instead, the composition is ground and the powder pressed into shape by compression molding.

European Patent Specification No. 0,189,469 (1985) discloses a method for mixing a liquid polyol with tempered conventional chocolate mass before depositing it into molds. Polyols that are liquid at ambient temperatures (such as glycerol) are preferred, though the patent teaches that higher melting polyols (such as sorbitol) can also be used. The mixture is held at slightly elevated temperatures (24° C. to 35° C.) for a short period of time during which the viscosity rises. This is stated to be the result of a chemical reaction between the fat and the polyol. The time and temperature of the holding period are critical parameters that control the viscosity increase—the viscosity must remain low enough for the subsequent molding or enrobing operations. The finished chocolate product is reported to have sufficient internal structure to remain solid above the melting temperature of the fat.

A method using emulsification to avoid too rapid an incorporation of water into the chocolate mass is disclosed in U.S. Pat. No. 4,446,166 (1983). An oil-in-water emulsion (typically 50% water, 50% fat) is prepared with cocoa butter using lecithin as the emulsifier. The emulsion is cooled and milled to give partially or entirely solid particles that are then added to the chocolate mass at levels of between 2 and 10%. Once incorporated in the warmer liquid chocolate mass, the emulsion particles will melt, releasing the water droplets. A disadvantage of this method is the need to guarantee a homogeneous distribution of the emulsion particles before they melt. Premature release of water causes a sudden increase in viscosity that renders the chocolate unsuitable for molding or enrobing.

European Patent Application No. 0,297,054 (1988) teaches an improved method for homogeneously dispersing the water using an aqueous foam. The foam is stabilized with an edible foaming agent (such as egg albumin) and added to conventionally prepared chocolate mass after tempering. The patent teaches adding the foam at levels that deliver from 0.5 to 2% of water reportedly with no noticeable increase in viscosity to provide a treated chocolate usable for molding or enrobing. The trapped gases can be removed from the still liquid product by exposing it to reduced pressure. European Patent Application No. 0,407,347 B 1 teaches the same method but discloses a broader range of foaming agents. These include esters of fatty acids (preferably saturated, with more than 12 carbon atoms) and glycols and polyols (e.g., erythritol, inositol, glycerol mono-di- and triglycerides, sorbitol and the polyalkylene glycols).

European Patent Application No. 0,393,327 B1 (1990) discloses another variation in which the aqueous phase of the water-in-oil emulsion contains sugars (such as sucrose or glucose) or polyols (such as sorbitol). The patent teaches preparation of the emulsion with 30 to 60% fat using emulsifying agent at a level of 0.1 to 3%. Suitable emulsifying agents are lecithin, glycerol fatty acid ester, polyglycerol fatty acid ester, polyglycerol condensed ricinoleic acid ester and sucrose fatty acid ester that has an HLB not more than 7. The level of sugar or polyol in the aqueous phase of the emulsion can be between 20 and 60% and the level of water between 15 and 25%. The sugar or polyol in the aqueous phase is reported to provide smoother texture to the heat-stable chocolate mass. A storage period of about 20 days, however, is required for proper development of internal structure.

A similar method is disclosed in European Patent No. 0,442,324 A2 (1991). An oil-in-water emulsion is prepared by mixing 30-80% of an oil or fat (for example, cocoa butter) in water containing a small amount of a suitable emulsifier. This emulsion is mixed at a level of about 5% with a conventionally manufactured and tempered chocolate mass that is then molded. It is stated to be important to control the temperature to be no higher than 90° F. to keep the oil-in-water emulsion stable. The homogeneously dispersed water generates a viscosity increase of the chocolate mass during solidification of the finished product. However, it is still necessary to store the molded product for several days to establish heat stability.

A variation of this is disclosed in U.S. Pat. No. 5,486,376 (1996). These inventors describe the use of water-in-oil microemulsions to introduce finely dispersed water into chocolate mass. A more recently disclosed form of this technology is described in U.S. Pat. No. 6,159,526 (2000). Water is added to the chocolate as a water-in-oil emulsion stabilized by sucrose fatty acid esters (HLB<3). The invention is concerned primarily with adding water-based flavors to chocolate.

Another more recent patent immobilizes water within other ingredients before adding it to chocolate. International Patent No WO 93/06737 (1993) discloses methods for making pastes and creams by adding water to “Raftiline” (inulin), starches (potato and corn), “Splendid”, or gum arabic. The paste is then added to tempered chocolate that is molded within ten minutes to give a heat-resistant product with a moisture content of approximately 2.5%.

U.S. Pat. No. 5,468,509 (1995) discloses a method for adding up to 16% water to chocolate. The chocolate supposedly remains moldable. Two mixtures are prepared. (1) Cocoa is coated with cocoa butter in the presence of an emulsifier and (2) water, a sweetener and milk solids are blended to form an aqueous phase. The two are gently blended and the product molded.

A process for adding water to chocolate using extrusion technology is disclosed in U.S. Pat. No. 5,965,179 (1999). The water is added as an aqueous dispersion of microcrystalline cellulose (described as a “gel”). This dispersion is injected into the chocolate using a twin-screw extruder so as to form a product containing 3 to 20% of added water.

These prior art references all have one or more deficiencies such as the release of water into the chocolate mass, which occurs early in the process and is not retarded for long enough for the material to be used for typical enrobing processes; the dispersion and release of water is not under sufficiently fine control to avoid development of unpleasantly gritty textures in the final product; and/or an inconveniently long storage time is required for full development of the structures required to provide stability.

Thus, it is still desired to provide a tropicalizing agent that delays any substantial increase in viscosity so the materials can be used for conventional molding or enrobing processes and that provides a suitable texture and stability, or integrity, in the tropicalized product after a brief storage time.

### SUMMARY OF THE INVENTION

The invention encompasses tropicalizing agents including a liquid fat component, and a plurality of gel beads which include a sugar, a polyol, or any combination thereof, in an amount of about 20 to 50 weight percent of the gel beads, and an emulsifier component to facilitate uniform gel bead size distribution, with the remainder being water present in an amount sufficient to ensure that the sugar and/or polyol is present in aqueous form temporarily entrapped within the gel beads. In a preferred embodiment, the liquid fat component is present in an amount sufficient to disperse the gel beads therein and wherein a majority of the gel beads remain substantially intact, in the tropicalizing agent, for at least about 8 hours after being cooled below about 40° C. The gel beads preferably contain about 20 to 60 weight percent water, and they are typically microscopic. Also, in a preferred embodiment the majority of the gel beads of the tropicalizing agent remain substantially intact, in the liquid chocolate or chocolate analogue, for at least 4 hours after being cooled to below about 30° C. In another preferred embodiment, the emulsifier component is present in an amount sufficient so a plurality of sol precursors of the gel beads form a water-in-oil emulsion with the liquid fat component, prior to their gelling.

In a preferred embodiment, the gel beads further include a gelling component in an amount sufficient to facilitate gelling of the gel beads. Typically, when present, the gelling component is present at less than about 6 weight percent of the tropicalizing agent, and includes at least two of kappa-carrageenan, iota-carrageenan, locust bean gum, agar, alginate, one or more milk proteins, and gelatin. In a preferred embodiment, the gelling component includes at least kappa-carrageenan, iota-carrageenan, and locust bean gum. In a preferred embodiment, the gelling component is fully dissolved in the sugar and/or polyol syrup to facilitate dispersal of the sol precursors of the gel beads within the liquid fat component.

In a preferred embodiment, the gel beads further include a gel setting agent in an amount sufficient to facilitate gelling of the gel beads. Typically, when present, the gel setting agent is present at less than about 0.5 weight percent of the tropicalizing agent.

Preferably, the gel beads are at least substantially spherical. The gel beads typically have an average size, e.g., of about 20 to 80 microns diameter. In a preferred embodiment, the liquid fat component includes cocoa butter or one or more cocoa butter substitutes.

It is desired that at least substantially all of the gel beads remain intact for at least about 8 hours of formation of the tropicalizing agent, preferably after formation of a chocolate or chocolate analogue containing the same. In one preferred embodiment it is only after a trigger mechanism, such as cooling the chocolate or chocolate analogue, that the gel beads of the tropicalizing agent then slowly release their contents. In one preferred embodiment, the tropicalizing agent provides no more than about 1.5 weight percent water (as part of the sugar and/or polyol syrup) to the chocolate or chocolate analogue.

In one embodiment, the sugar and/or polyol syrup that is released from the gel beads of the tropicalizing agent changes the structure of the sugar in the chocolate or chocolate analogue such that it becomes present in the form of a plurality of thin rings or chains of crystals. Typically, these rings or chains have a size, i.e., a diameter or length, respectively, of about 50 μm to 500 μm, and preferably 100 μm to 300 μm, and typically a thickness of only 1 to 5 sugar crystals.

The gelling component is typically provided in an amount of about 0.2 to 1.2 percent by weight of the aqueous phase of the tropicalizing agent. In one preferred embodiment, the sugar or polyol includes sucrose. In another preferred embodiment, the liquid fat includes one or more vegetable fats that are the same as a fat used in preparing the chocolate analogue mass so as to increase the compatibility and stability of the tropicalized chocolate mass.

Each of the above-described embodiments applies equally to the additional aspects of the invention discussed below.

The invention encompasses a chocolate or analogue thereof formed from the tropicalizing agent in an amount sufficient to increase the integrity and shape retention of the chocolate or analogue thereof. In one embodiment, the gel beads of this chocolate or analogue thereof include sugar crystals present in the form of a plurality of rings or chains each having a size in diameter or length of about 50 μm to 500 μm.

The invention also relates to a process for preparing a tropicalizing agent by providing a plurality of gel beads including one or more sugars or polyols in an amount of about 20 to 50 weight percent of the gel beads, an emulsifier component to facilitate uniform gel bead size distribution, and the remainder being water present in an amount sufficient to ensure that the sugar or polyol, or both, is present in aqueous form, and dispersing the gel beads in a liquid fat component present in an amount sufficient to disperse the gel beads therein. Preferably, the emulsifier component is present in an amount sufficient such that the sol precursor of the gel beads forms a water-in-oil emulsion with the liquid fat component prior to gelling. In another preferred embodiment, the liquid fat component is present in an amount sufficient to disperse the gel beads therein and wherein a majority of the gel beads remain substantially intact for at least about 8 hours after being cooled below about 40° C.

The invention also encompasses a process for tropicalizing chocolate, or an analogue thereof, by combining a chocolate or a chocolate analogue mass, optionally a tempered chocolate mass or untempered chocolate analogue mass, with a sufficient amount of tropicalizing agent including (a) a plurality of gel beads comprising water (as syrup) in an amount of about 1 to 2 percent by weight of the tropicalized chocolate mass, an emulsifier component to facilitate uniform gel bead distribution, and sugar(s) or polyol(s), or both, in an amount of about 20 to 50 weight percent of the gel beads, and (b) a liquid fat component present in an amount sufficient to ensure the gel beads are dispersed therein, and initiating release of the syrup of water and sugar or polyol, or both, from the gel beads so as to increase the structure of the tropicalized chocolate mass. Preferably, the amount of tropicalizing agent is sufficient to increase the integrity and shape retention of the tropicalized chocolate mass compared to a non-tropicalized mass.

In one embodiment, the combining includes at least substantially uniformly dispersing the tropicalizing agent in the chocolate or analogue mass. Preferably, the mass can be pre-formed. In another embodiment, the initiating release includes reducing the temperature of the tropicalized chocolate mass to about −5° C. to −15° C. In yet another embodiment, the chocolate mass is at least partially tempered before combining the tropicalizing agent therewith. In another embodiment, the gel bead release can be initiated by providing energy sufficient to cause a majority of the beads to begin to disintegrate, e.g., microwaves, ultrasonic, or the like, or any combination thereof.

### BRIEF DESCRIPTION OF THE DRAWINGS

Further features and advantages of the invention can be ascertained from the following detailed description that is provided in connection with the drawing(s) described below:

FIG. 1 illustrates a plot of apparent viscosity (in Brabender units) for chocolate with addition of 1.5% water as sucrose syrup dispersed as tropicalizing agent according to the invention;

FIG. 2 illustrates a diagrammatic representation of the drop test to test food product stability; and

FIG. 3 illustrates a microscopy image of a gel bead during cooling of a chocolate mass showing the triggering of the syrup release according to the invention.

### DETAILED DESCRIPTION OF THE PREFERRED EMBODIMENTS

The present invention provides new tropicalizing agents that can be used to stabilize other food products for tropical, or other hot, conditions, as well as a new way to manufacture chocolates and chocolate analogues that are suitable for storage, transport, and sanitary consumption under tropical conditions. The chocolate or other food products tropicalized with the tropicalizing agents of the invention can be used to manufacture molded or enrobed products and the final products do not have the gritty texture encountered in chocolates tropicalized by conventional methods such as those noted above. The tropicalizing agent of the invention is advantageously achieved by including a liquid fat component, and a plurality of gel beads that include one or more sugars, polyols, or both, in an amount of about 20 to 50 weight percent of the gel beads, with the remainder being water present in an amount sufficient to ensure that the sugar or polyol is present in aqueous form. The aqueous form is typically a syrup. It is preferred that the liquid fat component is present in an amount sufficient to disperse the gel beads therein, and that a majority of the gel beads remain substantially intact for at least about 8 hours after being cooled below about 40° C.; and that a majority of the gel beads remain substantially intact for at least 4 hours after being cooled in the final product below about 30° C. The cooling optionally, but preferably, takes place in the presence of a gel setting agent, which can be included in the gel beads or elsewhere in the tropicalizing agent, or in the final food product to which the tropicalizing agent is added. Preferably, the gel beads also include an emulsifier component in an amount sufficient to form a water-in-oil emulsion of the sol precursor of the gel beads with the liquid fat component prior to gelling. Optionally, but preferably a gelling component in an amount sufficient to facilitate gelling of the gel beads can be included in the tropicalizing agents of the invention. Optionally, a gel setting agent in an amount sufficient to facilitate gelling of the gel beads can also be included in the tropicalizing agents of the invention.

The liquid fat component can be any vegetable fat or oil suitable for use in edible foods. The liquid fat can include cocoa butter, particularly where the tropicalizing agent will be used in chocolate products. Preferably, however, the liquid fat includes one or more cocoa butter substitutes, particularly where the tropicalizing agent will be used in chocolate analogues. In another preferred embodiment, the liquid fat preferably includes one or more vegetable fats, e.g., non-lauric vegetable fats. Preferably, the tropicalizing agents are included in chocolate analogues rather than chocolate. Preferably, the vegetable fat is the same fat or at least one of the same fats, used in preparing the chocolate analogue mass so as to increase the compatibility and stability of the tropicalized chocolate mass. A sufficient amount of liquid fat component can include from about 30 to 70 weight percent, preferably about 40 to 60 weight percent of the tropicalizing agent.

The gel beads typically contain from about 20 to 50 weight percent of a syrup that includes sugars, polyols, or both, which is in water. In a preferred embodiment, the aqueous syrup of the gel beads includes at least one sugar. Preferred sugars include sucrose, fructose, glucose, dextrose, lactose, maltose, corn syrup solids, or a mixture thereof. A more preferred sugar includes sucrose. In another embodiment, the aqueous syrup of the gel beads includes one or more polyols, optionally with at least one sugar. Preferred polyols include glycerol, maltitol, mannitol, sorbitol, erythritol, inositol, xylitol, glycerol mono-di- and triglycerides, a polyalkylene glycol, or a mixture thereof. Preferably, when a polyol is used it includes sorbitol. In one embodiment, the gel beads are preferably present in an amount of about 45 to 65 weight percent, more preferably about 50 to 60 weight percent of the tropicalizing agent. The aqueous portion of the tropicalizing agent is also used to form the remainder of the gel beads. Water can be present in the tropicalizing agent in an amount of about 20 to 80 weight percent, preferably about 25 to 65 weight percent, and more preferably about 30 to 50 weight percent.

Without wishing to be bound by theory, it is understood that the release and migration of aqueous syrup from the dispersed gel beads is different than that of water, and that the effect of aqueous syrup upon the natural sugar crystals within the chocolate or chocolate analogue is different to that of water. Surprisingly, the effect is to enable a control over viscosity increase until a trigger is applied during processing. Surprisingly, the effect occurs while being able to minimize or avoid the gritty textural quality that is associated with large sugar crystal clusters and that is inevitable in conventional tropicalized food products, such as chocolates and analogues thereof prepared by prior art methods.

The tropicalizing agent typically includes about 30 to 70 weight percent liquid fat and 30 to 70 weight percent gel beads. Preferably, the agent includes about 40 to 60 weight percent liquid fat and 40 to 60 weight percent gel beads, and more preferably about 45 to 55 weight percent liquid fat and 45 to 55 weight percent gel beads. An exemplary agent includes 50 percent liquid fat and 50 percent gel beads before considering the addition of other preferred components including an emulsifier component and a gelling component. In another preferred embodiment, the liquid fat may be present in a ratio with the gel beads of about 3:1 to 1:3, preferably a ratio from about 2:1 to 1:2, and in one more preferred embodiment from about 1.2:1 to 1:1.2.

The tropicalizing agent optionally but preferably includes an emulsifier component in an amount sufficient to form a water-in-oil emulsion of the sol precursor of the gel beads with the liquid fat component prior to gelling, and an amount of emulsifier sufficient to maintain dispersion of the gel beads after gelling, as well as a gelling component with an optional gel setting agent in an amount sufficient to facilitate gelling of the gel beads, or any combination thereof. The need for a gel setting agent, and the type and amount of gel setting agent selected, depends on the optional, but preferably included, gelling component. The type and amount of gel setting agent, if any, will be readily determinable by one of ordinary skill in the art in view of the gelling component and the description of the invention herein. Preferably, any gel setting agent includes a salt. An exemplary gel setting agent includes potassium chloride, calcium chloride, or a combination thereof. The optional gelling component and gel setting agent are typically included in the gel bead portion of the tropicalizing agent.

The emulsifier component can be any suitable emulsifier, and the tropicalizing agent preferably includes the emulsifier component to facilitate uniform gel bead distribution throughout the liquid fat. While the distribution or dispersal may not be perfectly uniform, the emulsifier component increases the uniformity of dispersion. Preferably, the gel beads are at least substantially uniformly dispersed in the liquid fat. Preferably, the emulsifier component includes soy lecithin. The emulsifier, when used, is typically present in the tropicalizing agent in an amount from about 0.001 to 1 weight percent, preferably from about 0.05 to 0.2 weight percent.

The gelling component can include any suitable combination of one or more materials, typically hydrocolloids, that will facilitate gelling of the gel beads and provide the correct degree of brittleness for the gel to break or leak when suitably “triggered” according to the invention in the processing of the final product. Preferably, the gelling agent is a mixture of at least two of kappa-carrageenan, iota-carrageenan, locust bean gum, agar, alginate, one or more milk proteins, or gelatin. Preferably, the gelling component includes a mixture of kappa-carrageenan, iota-carrageenan, and locust bean gum. It is important to ensure that the hydrocolloids are at least substantially dissolved, and preferably completely dissolved, in the aqueous phase of the sol precursor of the gel beads to facilitate gelling. The gelling agent is typically present in an amount of 0.001 to 0.25 weight percent, preferably from about 0.005 to 0.1 weight percent of the total tropicalized food product. An exemplary amount is about 0.015 weight percent in the tropicalized food product. Within the tropicalizing agent itself, however, the gelling agent can typically be present in an amount of about 0.1 to 6 weight percent. Preferably, total gum content is present at a concentration of about 0.3 to 2 weight percent.

The tropicalizing agent of the present invention is prepared by forming microscopic gel beads in situ within a cooling liquid fat component. The gel beads are prepared by dispersing the hot sol with a suitable emulsifier component in a liquid fat to form a water-in-oil emulsion. The gel beads form on cooling from elevated temperatures, e.g., cooling to about 55° C., cooling to about 45° C., or cooling to about 35° C. The most suitable conditions for the preparation of the gel beads depend primarily on the choice of fat, which should remain liquid at the gelling temperature of the gel beads. The resulting gel beads of the tropicalizing agent should be predominantly spherical and a size of about 10 to 90 microns diameter, preferably from about 20 to 70 microns. In a preferred embodiment, the volume average gel bead size is about 25 to 50 microns, preferably about 35 to 45 microns.

The tropicalizing agent of the invention can be dispersed within food products to facilitate stability of the final product even at high temperatures, such as those up to about 40° C. The temporarily entrapped aqueous syrup of the tropicalizing agents is dispersed within the food, preferably chocolate or an analogue thereof, as a plurality of microscopic gel beads. Preferably, the syrup is at least substantially uniformly dispersed, and more preferably it is uniformly dispersed, in the food product. Without being bound by theory, it is believed that water is released under controlled conditions, then causes the development of a fine three-dimensional network of sugar crystals that maintains the structure of the food product even at elevated temperatures up to about 40° C.

The desired gel ingredients, e.g., optionally a gelling agent, a syrup including sugar(s) or polyol(s), or both, optionally an emulsifier component, are dissolved in water, at normal temperatures typically of less than 100° C. This solution (or rather sol) is cooled to just above gelling temperature, e.g., within about 10° C., preferably within about 5° C., then dispersed in the liquid fat component, optionally with an emulsifier component, and cooled until the dispersed phase gels, to form the tropicalizing agent of the invention.

When desired to incorporate the tropicalizing agent in a food product, the gel beads dispersed in liquid fat are blended into a liquid food mass using a mixing action that is insufficient to break or otherwise disrupt any significant amount of the beads. Tropicalizing agent including the beads should be added such that the quantity of syrup water added to the chocolate or chocolate analogue, or other food product, is about 1 to 2 weight percent to provide sufficient tropicalization. Preferably, the syrup water content provided to the food product from the gel beads is from about 1 to 1.5 weight percent of the total weight of the food product. Addition of too much tropicalizing agent, or of tropicalizing agent in which the gel contains insufficient gelling agent, or of tropicalizing agent in which the gel beads are too large, or of tropicalizing agent in which the gel beads are not sufficiently dispersed, can each tend to cause too rapid an increase in viscosity, particularly if multiple of these factors are present, for the product to be suitable for molding, enrobing, or both. This is particularly true for enrobing using conventional equipment. Molding can be used, e.g., to form bars of chocolate, or analogues thereof, containing tropicalizing agent according to the invention. Addition of tropicalizing agent, that contains too low a concentration of syrup can cause relatively large sugar aggregations to form, which can undesirably lead to grittiness in the final product. Addition of tropicalizing agent containing gel beads that are too small, or which contain too much gelling agent, can cause a failure of the required trigger release mechanism. Such concentrations and sizes can be readily determined through routine experimentation by those of ordinary skill in the art once reference it made to the invention described herein.

One exemplary tropicalizing agent provides a tempered chocolate mass (or an untempered chocolate analogue) with about 1 to 2 percent water by weight of the resulting chocolate, with the water being present in the form of an aqueous solution of sucrose of concentration from about 20 and 50% by weight in gel beads dispersed in a liquid fat.

The gelling agent in the tropicalizing agent facilitates control of syrup release kinetics into the food mass. The release can be made sufficiently slow to avoid a significant increase in the viscosity of the liquid food mass for many hours, making the tropicalized food product suitable for use in the manufacture of molded or enrobed products. By “significant increase” it is meant a viscosity increase that would prohibit a conventional molding or enrobing process. Preferably, the viscosity increase is limited to that caused by the presence of the gel beads, less than about 20 percent, more preferably less than about 10 percent. Any subsequent viscosity increase, caused by syrup release from the gel beads, should be sufficiently slow to typically occur over a period of up to about 4 hours, preferably 8 hours. The majority of the gel beads remain at least substantially or completely intact during this time period, as disintegration of the gel beads releases syrup that would begin to increase the viscosity of the tropicalized food product. Preferably, at least about 80 percent of the beads, and more preferably at least about 95 percent of the beads, remain at least substantially intact during this time period.

After this initial time period where significant viscosity increase of the tropicalized food product is retarded or avoided, it is then desirable to accelerate, or initiate by trigger mechanism, the release of syrup from the gel beads within the finished food products to provide a tropicalizing effect. This provides the stability and heat resistance that is so advantageously provided to food products, particularly those for use in tropical or hot environments. This is especially true with chocolate or analogues thereof, where heat tends to create a messy product as well as reducing or eliminating the desired snap of chocolates when consumed in more reasonable environments. Thus, the invention provides a tropicalizing agent and tropicalized products that are suitable for molding or enrobing or other processing where non-increased viscosities are desired, but then has a viscosity increase triggered after molding, enrobing or otherwise shaping the tropicalized product to achieve the ultimately desired tropicalization.

The gel release mechanism is initiated in one or more of several ways when a finished food product, such as chocolate or an analogue thereof, contains the tropicalizing agent of the invention. For example, the tropicalized mass or finished food product can be cooled for a sufficient time and to a temperature that is sufficiently low. The food product is cooled to a temperature below about 25° C., preferably below about 15° C. after the addition of gel beads to initiate the gel bead disintegration. Preferably, the initiation cooling is to a temperature of about −5° C. to −15° C. This cool temperature is typically held for about 5 to 120 minutes, preferably from about 15 to 45 minutes. Other suitable times may be used for the initiation cooling as well, which will be dependent on the specific temperature, food product, and components used in forming the tropicalizing agent. The gel release can be initiated by providing energy into the tropicalized mass, as well. For example, microwaves or ultrasonic energy can be provided in an amount suitable to initiate the gel bead disintegration and eventual release of the syrup.

After the release is initiated, the syrup is released over time from the well dispersed microscopic gel beads in the tropicalizing agent and begins to form rings or chains, or both, from the naturally occurring sugar crystals in the food product. The syrup of sugar or polyols or both forms localized spots of adhesion. Preferably, the total evolution of the syrup from the damaged gel beads takes at least about 4 hours after initial gel bead damage, and more preferably it takes at least about 8 hours, with the release taking place concurrently or subsequent to the bead damage initiated by the trigger mechanism. These released syrups eventually create fine structures, i.e., sugar crystal rings or chains, that increase the strength of the food product, without causing grittiness, and provides the necessary form, integrity and stabilization even at subsequent temperatures as high as about 40° C. Importantly, the syrup materials typically do not create aggregates that are sufficiently large to be detected by a consumer as being excessively gritty.

Cooling is not necessarily required, as the food products will stabilize over time once tropicalized even without the cooling. In this embodiment, full shape retention occurs over about 10 to 14 days under ambient conditions. When the above-described cooling is used, however, the optimum shape retention time occurs within about 18 to 30 hours.

Advantageously, the resultant food products including a tropicalizing agent according to the invention do not stick to a wrapper even at temperatures as high as 40° C., do not result in adverse appearance or mouthfeel, and in chocolate or analogues thereof do not have adverse effects on bloom. Moreover, the food products, particularly chocolates and chocolate analogues, typically can have at least about 80% shape retention, preferably at least about 90% shape retention, when chocolate or analogues thereof at 40° C. are dropped 18 inches and tested according to the method described below. Another advantage that can be obtained with the present invention if desired is the ability to use conventional ingredients for chocolate or analogues thereof while still achieving the suitable tropicalizing effect.

When prepared with maximum structural integrity, tropicalized chocolates or analogues thereof prepared according to the invention have at least about 80 percent shape retention, preferably at least about 95 percent shape retention, and in a more preferable embodiment at least about 98 percent shape retention.

The food products including tropicalizing agent of the invention can advantageously be used in tropical countries where hot weather causes frequent or rapid melting of chocolate, chocolate analogues, or other confectionery products where the melting temperature is below or about the ambient temperature. For example, chocolate analogues including coatings and couvertures, which are thin and tend to melt rapidly, can surprisingly and advantageously be formed with the tropicalizing agent of the invention. The food products including tropicalizing agent of the invention remain non-sticky so as to smoothly slide out of a wrapper and to avoid leaving food product on the consumer's fingers during consumption.

### EXAMPLES

The following examples are not intended to limit the scope of the invention, but merely to illustrate representative possibilities concerning the present invention.

Measurements carried out with Brabender thermorheograph showed no significant increase in viscosity of a tropicalized chocolate analogue of the invention over a period of 8 hours after addition of the tropicalizing agent.

Brabender Thermorheograph

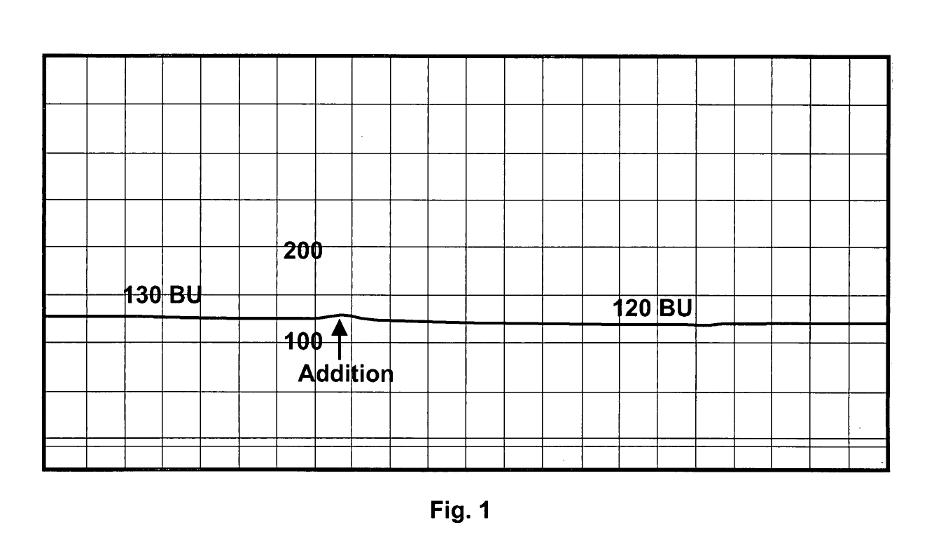

A Brabender thermorheograph was used to follow the change of apparent viscosity following addition of tropicalizing agent to liquid chocolate. The thermostat was set to give a constant temperature of 30° C. and the instrument was loaded with tempered chocolate. The instrument was set to Speed I and run until thermal equilibrium was reached. A measured aliquot of tropicalizing agent was then added (a weight calculated to deliver 1.5% of water to the chocolate mass) directly into the vortex while the paddles were turning. The apparent viscosity was followed (with continual mixing) against time. A typical trace is shown in FIG. 1. The instrument measures apparent viscosity in arbitrary Brabender units (BU) at a fixed rate of shear (depending on the speed setting).

It should be understood that FIG. 1 illustrates a plot of apparent viscosity (in Brabender units) for chocolate with addition of 1.5% water as sucrose syrup dispersed as tropicalizing agent. Each major (heavy lined) division on the horizontal (x) dimension represents 30 minutes. In this typical case apparent viscosity only increased slightly on addition of tropicalizing agent. Surprisingly, no viscosity increase (caused by syrup release from the tropicalizing agent—that would occur after the addition) is observed over a significant period of time. This helps demonstrate the delayed release of water from the gel beads. Operating temperature was attained before addition and then maintained.

Measurement of Shape Retention

The test method described gives a quantitative shape retention index (SRI) that can be used in any laboratory and does not require specialized rheometry. The SRI is zero for a material that is indistinguishable from untreated chocolate and 100 for a material that has perfect shape retention at 40° C.

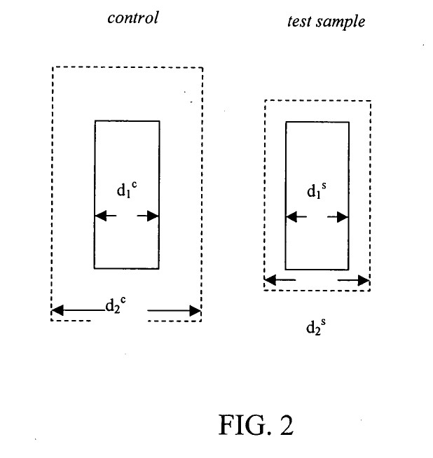

Equipment required: Tray (metal or plastic—plastic is preferable), 18″ ruler, balance accurate to ±0.1 g, calipers capable of measurement to ±0.1 mm, oven set at 40° C. The chocolate is molded into bars, typically 4.1″×1.1″×0.2″ and the following test method is used to determine the SRI:
1. Take 5 of the bars of the invention to be tested and an equal number of untreated chocolate bars as controls. Weigh each bar and measure its width at 10 points equally spaced along its length.
2. Place the labeled bars on the tray and place in the oven at 40° C. for one hour.
3. Drop tray from a height of 18″, so as to land flat on laboratory bench. (Use a ruler to measure the height. Take care to hold the tray horizontally so it hits the bench flat.)
4. When the bars have cooled and hardened, re-measure each width at 10 points 1 cm apart along the length.
5. Calculate the shape retention index (SRI):

$$SRI = 100 \cdot ( 1 - \frac{{d}_{2}^{s} - {d}_{1}^{s} )}{{d}_{2}^{c} - {d}_{1}^{c}} \cdot \frac{{w}^{c}}{{w}^{s}} )$$

where d₁ and d₂ are the average widths before and after dropping, w is the bar weight and the superscripts s and c refer to the test sample and control bars (see FIG. 2). FIG. 2 shows a diagrammatic representation of the drop test so that the shape retention index may be calculated in a more quantitative manner. The solid rectangles indicate the initial footprint of the bar; the dotted rectangles the footprint of the bar after the drop test.

### Example 1

### Development of Network Structure in Tropicalized Chocolates of the Invention

Tropicalizing agent was added at 40° C. to tempered chocolate at levels equivalent to various additions by weight of water as sucrose syrup and the product molded into bars. These were set at room temperature (22° C.) and then placed in a freezer at −10° C. for 30 minutes. The shape retention indices were measured after a further 24 hours at room temperature. The results (shown in Table 2) indicate that 0.5% addition of water was insufficient for the development of structure whereas good shape retention is obtained with a 1.5% addition of water.

TABLE 1
Shape retention in chocolate with different additions
of water as sugar syrup in gel beads.

| | | | | |
|---|---|---|---|---|
| Water addition (% by weight) | 0.5 | 1.0 | 1.5 | 2.0 |
| SRI (%) | 0 | 35 | 91 | 96 |

A small sample of the treated chocolate according to the invention was placed on a microscope and examined under 100× magnification. A network structure of rings and chains of concatenated sugar crystals was seen. These structures were not found in untreated conventional chocolate.

### Example 2

### Acceleration of Release of Syrup from Gel Beads of the Invention

Cooling the treated chocolate (or treated chocolate analogue), e.g., to −10° C., greatly increases the rate of development of shape retaining characteristics. Tropicalizing agent was added at 40° C. to tempered chocolate at a level equivalent to addition of 1% by weight of water as sucrose syrup and the product was molded into bars. These were set at 12.5° C. and then equal numbers were placed in a freezer and cooled to −10° C. or retained in the refrigerator at 12.5° C. for 30 minutes. The shape retention indices were then measured. The bars held at −10° C. had very much better shape retention than those held at +12.5° C., as shown in Table 3. After 12 days storage under ambient conditions (ca 22° C.) the shape retention indices were more equal, but the bars held at −10° C. for 30 minutes still retained better shape retention characteristics.

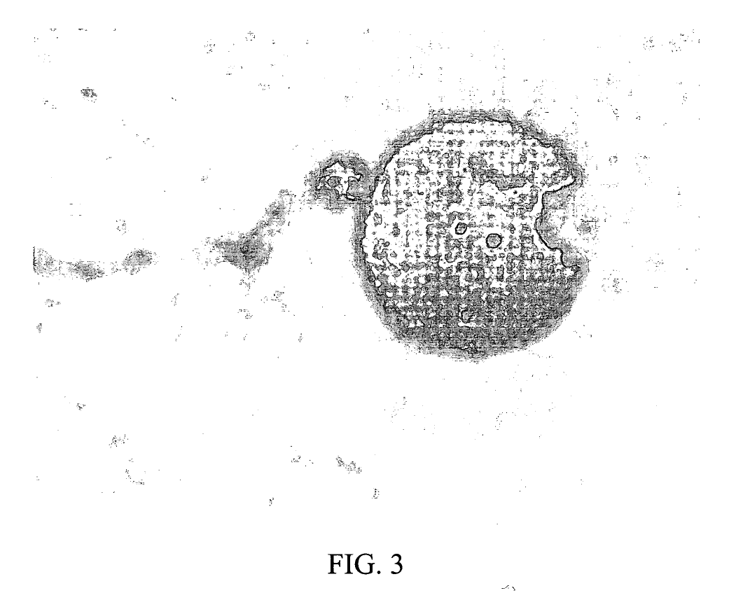

FIG. 3 illustrates an image of a gel bead during fat crystallization, which shows a microscopy image of a gel bead during cooling of chocolate showing the triggering of the syrup release. The gap on the right hand side is a fat crystal from fat crystallizing in the chocolate, and the trail on the left of the image shows a release of syrup from the gel bead.

TABLE 3
Comparison of the effects on shape retention of
storage for 30 minutes at two different temperatures.

SRI (%)

| 30 minute holding temperature | Day 4 | Day 12 |
|---|---|---|
| −10° C. | 88 | 94 |
| +12.5° C. | 50 | 89 |

### Example 3

### Shape Retention Based on Length of Cooling Time of the Invention

Tropicalizing agent prepared per Example 1 was added to tempered chocolate at 40° at a level equivalent to addition of 1.5% water as sugar syrup and the product molded into bars. These were set at 12.5° C. and then placed in a freezer at −10° C. for different lengths of time (as shown in Table 3). The shape retention index (SRI) reached its maximum value within 15 minutes, as shown in Table 4.

TABLE 4
Effect on shape retention of different holding times at −10° C. for
chocolate treated with tropicalizing agent delivering an equivalent
1% by weight addition of water as sucrose syrup.

| | | | | |
|---|---|---|---|---|
| Time at −10° C. (minutes) | 15 | 30 | 45 | 60 |
| SRI (%) | 97 | 98 | 97 | 96 |

### Example 4

### Rate of Shape Retention of Products of the Invention

The rate of development of shape retention also increases with the level of syrup addition to chocolate, as shown in Table 5. These results show that at equivalent levels of water addition of 1.5 and 2% shape retention had almost peaked within one day whereas with 0.5 and 1% equivalent water addition shape retention increased over a period of 6 days.

TABLE 5
Comparison of shape retention in chocolate made with
tropicalizing agent after 1 and 6 days with different levels
of equivalent water addition (as sugar syrup).

| | |
|---|---|
| Water addition | SRI (%) |

| (%) | Day 1 | Day 6 |
|---|---|---|
| 0.5 | 0 | 35 |
| 1.0 | 35 | 79 |
| 1.5 | 91 | 96 |
| 2.0 | 96 | 98 |

Cooling to −10° C. also increased that rate of structure development in a chocolate analogue. Tropicalizing agent was added to a chocolate analogue at a level equivalent to addition of 1% by weight of water as sucrose syrup (5.2 g gel beads added to 200 g chocolate analogue) and the product molded into bars. These were set at 3.5° C. and then placed in a freezer at −10° C. for different lengths of time (as shown in Table 5). The shape retention index (SRI) increased with increasing time of exposure to the low temperature, reaching its maximum value within 45 minutes, as shown in Table 6.

TABLE 6
Effect on shape retention of different holding times at −10° C. for
a chocolate analogue treated with tropicalizing agent delivering an
equivalent 1% by weight addition of water as sucrose syrup.

| | | | | |
|---|---|---|---|---|
| Time at −10° C. (minutes) | 15 | 30 | 45 | 60 |
| SRI (%) | 23 | 52 | 56 | 56 |

### Example 5

### Tropicalizing Agent and Tropicalized Chocolate of the Invention

Tropicalizing agent was prepared with a composition as follows:

| | | |
|---|---|---|
| Kappa-carrageenan | 1.5 | g |
| Iota-carrageenan | 1.5 | g |
| Locust bean gum | 1.5 | g |
| Potassium chloride | 0.6 | g |
| Sucrose | 180 | g |
| Water | 420 | g |
| Cocoa butter | 482 | g |
| Soy lecithin | 1.5 | g |

1. The water and sucrose were mixed and heated until the sucrose was completely dissolved and the mixture had come to a boil. The solution was then maintained at a temperature between 90° and 95° C.
2. The cocoa butter was heated in a bain marie to 95° C.
3. The hot sugar solution was stirred with a Silverson mixer and the hydrocolloids and potassium chloride gradually added into the vortex. This solution (sol) was set aside.
4. The fat and emulsifier component were mixed using a Silverson mixer. The aqueous solution of sugar and hydrocolloids were then added into the vortex.
5. The mixture was emulsified at 5,000 rpm while being cooled in an ice bucket to 40° C.

This produced the tropicalizing agent containing gel beads with a volume average diameter of 40 microns and ranging in size from about 18 to 70 microns.

The tropicalizing agent was added to tempered chocolate at 40° C. in an amount calculated to deliver 1.5% water (39 g of tropicalizing agent added to 1000 g of a chocolate). The chocolate was molded into conventional-shape bars, cooled to 12.5° C., then placed in a freezer and further cooled to −10° C. for 30 minutes.

The shape retention index was 98%. The product retained its shape well at 40° C. and could be removed from plastic packaging without sticking at that temperature. It retained a smooth texture.

### Example 6

### Tropicalizing Agent and Tropicalized Chocolate Analogue

Tropicalizing agent was prepared with a composition as follows:

| | | |
|---|---|---|
| Kappa-carrageenan | 1.5 | g |
| Iota-carrageenan | 1.5 | g |
| Locust bean gum | 1.5 | g |
| Potassium chloride | 0.6 | g |
| Sucrose | 180 | g |
| Water | 420 | g |
| Cocoa butter | 482 | g |
| Soy lecithin | 1.1 | g |

1. The water and sucrose were mixed and heated until the sucrose was completely dissolved and the mixture had come to a boil. The solution was maintained at a temperature between 90° C. and 95° C.
2. The cocoa butter was heated in a bain marie to 95° C.
3. The hot sugar solution was stirred with a Silverson mixer and the hydrocolloids and potassium chloride gradually added into the vortex. This solution (sol) was set aside.
4. The fat and emulsifier component were mixed using a Silverson mixer. The aqueous solution of sugar and hydrocolloids was then added into the vortex.
5. The mixture was emulsified at 5,000 rpm while being cooled in an ice bucket to 40° C.

This produced tropicalizing agent containing gel beads with a volume average diameter of 62 microns and having a standard deviation of about 35 microns. The tropicalizing agent was added to pre-prepared chocolate analogue at 40° C. in an amount calculated to deliver the equivalent of 1.2% water (31 g of tropicalizing agent added to 1000 g of chocolate analogue). The chocolate analogue was molded into conventional-shape bars, cooled to −3.5° C., then placed in a freezer and cooled to −10° C. for 30 minutes.

The shape retention index was 96%. The product retained its shape well at 40° C. and could be removed from plastic packaging without sticking at that temperature. It retained a smooth texture.

The term “tropicalizing agent,” as used herein, generally refers to suitable materials according to the invention that increase the stability, or structural integrity, in a tropicalized food product into which they are incorporated. This structural integrity typically arises over the course of a brief storage time, and can permit the food product(s) into which the tropicalizing agent is incorporated to remain substantially or entirely solid or unmelted even under tropical temperatures, such as up to about 40° C. The term “tropicalizing agent” thus includes materials that provide foodstuffs with the characteristics of shape retention, heat resistance, and preferably both. Preferably, the term tropicalizing agent can also refer to suitable materials that also delay or avoid any substantial increase in viscosity of the foodstuff into which they are incorporated.

The term “substantially,” as used herein, has different meanings depending on the context in which is used. For example, the term “substantially all” of the gel beads means at least about 80 weight percent, preferably at least about 95 weight percent. In one embodiment, it refers to at least about 99 weight percent of the gel beads remaining intact. The term “at least substantially spherical” means that some deviation from a perfect sphere may occur, e.g., gel beads under pressure will flex from a perfect sphere shape, although this imperfect sphere shape can be deliberately provided if desired.

The term “about,” as used herein, should generally be understood to refer to both numbers in a range of numerals. Moreover, all numerical ranges herein should be understood to include each whole integer within the range.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

1. A tropicalizing agent comprising:
a liquid fat component;
a plurality of gel beads which comprise:
a sugar or polyol, or both, in an amount of about 20 to 50 weight percent of the gel beads;
an emulsifier component to facilitate uniform gel bead size distribution; and
the remainder being water present in an amount sufficient to ensure that the sugar or polyol is present in aqueous form,
wherein the emulsifier component is present in an amount sufficient so the gel beads form a water-in-oil emulsion with the liquid fat component, wherein the liquid fat component is present in an amount sufficient to disperse the gel beads therein and wherein a majority of the gel beads remain substantially intact to trap the aqueous form therein for at least about 8 hours after being cooled below about 40° C.

2. The agent of claim 1, wherein the gel beads further comprise a gelling component in an amount sufficient to facilitate gelling of the gel beads.

3. The agent of claim 2, wherein the gelling component is present in an amount of about 0.2 to 1.2 weight percent of the gel beads and comprises at least two of kappa-carrageenan, iota-carrageenan, locust bean gum, agar, alginate, milk proteins, or gelatin.

4. The agent of claim 1, wherein at least a majority of the gel beads remain substantially intact for at least about 4 hours after being cooled below about 30° C., and the tropicalizing agent contains about 20 to 60 weight percent water.

5. The agent of claim 1, wherein the gel beads are at least substantially spherical.

6. The agent of claim 1, wherein the gel beads have a volume average size of about 20 to 80 microns.

7. The agent of claim 1, wherein the liquid fat component comprises one or more cocoa butter substitutes.

8. A chocolate or analogue thereof comprising the tropicalizing agent of claim 1 in an amount sufficient to increase the structural integrity and shape retention of the chocolate or analogue thereof.

9. A chocolate or analogue thereof comprising the tropicalizing agent of claim 1, wherein the gel beads include sugar crystals present in the form of a plurality of rings or chains each having a size in diameter or length of about 50 μm to 500 μm.

10. A process for preparing a tropicalizing agent which comprises:
providing a plurality of gel beads comprising one or more sugars or polyols in an amount of about 20 to 50 weight percent of the gel beads, an emulsifier component to facilitate uniform gel bead distribution, and the remainder being water present in an amount sufficient to ensure that the sugar or polyol, or both, is present in aqueous form; and
dispersing the gel beads in a liquid fat component present in an amount sufficient to disperse the gel beads therein,
wherein the emulsifier component is present in an amount sufficient so the gel beads form a water-in-oil emulsion with the liquid fat component, wherein the liquid fat component is present in an amount sufficient to disperse the gel beads therein, and wherein a majority of the gel beads remain substantially intact to trap the aqueous form therein for at least about 8 hours after being cooled below about 40° C.

11. The process of claim 10, wherein the providing further comprises a gelling component that comprises at least two of kappa-carrageenan, iota-carrageenan, locust bean gum, agar, alginate, milk proteins, or gelatin.

12. The process of claim 11, wherein at least substantially all of the gel beads remain intact to trap the aqueous form therein for at least about 8 hours after formation of the tropicalizing agent and the tropicalizing agent contains about 20 to 60 weight percent water.

13. The process of claim 10, wherein the liquid fat component comprises one or more cocoa butter substitutes.

14. The process of claim 11, wherein the gelling component is fully dissolved to facilitate dispersal of the gel beads within the liquid fat component.

15. A process for tropicalizing chocolate or an analogue thereof, which comprises:
combining a chocolate or chocolate analogue mass with a sufficient amount of tropicalizing agent to form a tropicalized chocolate mass, with the tropicalizing agent comprising (a) a plurality of gel beads comprising water in an amount of about 1 to 2 percent by weight of the tropicalized chocolate mass, an emulsifier component to facilitate uniform gel bead distribution, and one or more sugars or polyols, or both, in an amount of about 20 to 50 weight percent of the gel beads that forms a syrup with the water that is temporarily retained in the gel beads, and (b) a liquid fat component present in an amount sufficient to ensure the gel beads are dispersed therein; and
initiating release of the syrup of water and sugar or polyol, or both, from the gel beads so as to increase the structure of the tropicalized chocolate mass, wherein the amount of tropicalizing agent is sufficient to increase the integrity and shape retention of the tropicalized chocolate mass compared to a non-tropicalized mass.

16. The process of claim 15, wherein the combining comprises at least substantially uniformly dispersing the tropicalizing agent in the mass.

17. The process of claim 15, wherein the initiating comprises reducing the temperature of the tropicalized chocolate mass to about −5° C. to −15° C.

18. The process of claim 15, wherein the chocolate mass is at least partially tempered before combining the tropicalizing agent therewith.

19. The process of claim 15, wherein the gelling component is present and comprises a mixture of at least two of kappa-carrageenan, iota-carrageenan, locust bean gum, agar, alginate, milk proteins, or gelatin.

20. The process of claim 15, wherein the gelling component is provided in an amount of less than about 0.5 weight percent of the tropicalized chocolate mass.

21. The process of claim 15, wherein the sugar or polyol comprises sucrose or sorbitol, or a combination thereof.

22. The process of claim 15, wherein the liquid fat component comprises one or more cocoa butter substitutes.

23. The process of claim 15, wherein the liquid fat comprises one or more vegetable fats that are the same as a fat used in preparing the chocolate analogue mass so as to increase the compatibility and stability of the tropicalized chocolate mass.
